(19) United States
(12) Patent Application Publication
(10) Pub. No.: US 2008/0300377 A1
(43) Pub. Date: Dec. 4, 2008

(54) Process for the preparation of Thermoplastic Polyurethanes based on 1,5-Naphthalene-Diisocyanate

(75) Inventors: Hartmut Nefzger, Pulheim (DE); James Michael Barnes, Breitscheid (DE); Hans-Georg Wussow, Dusseldorf (DE); Jens Krause, Koeln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 12/154,889

(22) Filed: May 28, 2008

(30) Foreign Application Priority Data
Jun. 1, 2007 (DE) 102007025660.6
Jun. 22, 2007 (DE) 102007028921.0
Jul. 6, 2007 (DE) 102007031546.7

(51) Int. Cl. C08G 18/02

(52) U.S. Cl. 528/65

(57) ABSTRACT

Thermoplastic polyurethanes (TPU) based on NDI are prepared by reacting specific, storage-stable NDI-based NCO prepolymers with chain extenders and granulating the largely reacted and cooled reaction melt. The TPU granules can then be processed to form shaped articles.

### BACKGROUND OF THE INVENTION

The present invention relates to a process for the preparation of thermoplastic polyurethanes (TPUs) based on 1,5-naphthalene-diisocyanate (NDI).

TPUs have been known for many years and are widely used. In general, they are predominantly built up from linear units and comprise long-chain polyols, diisocyanates and short-chain diols (chain extenders). The material properties can be varied within wide limits by the choice of the nature of the build-up components and the stoichiometry thereof. The elastomer properties in the temperature range in which the elastomer is to be used are a consequence of the microscopic phase separation of hard segment domains built up from diisocyanate and chain extender and the polyol matrix. To achieve sufficiently high molecular weights, a ratio of NCO groups to Zerewitinoff-active hydrogen atoms of approximately 1:1 is generally chosen. A slight NCO excess can optionally also be established in order to compensate reduced functionalities, e.g., as a consequence of the reaction of NCO groups with water. In some cases, however, small amounts of monofunctional components are also used in order to limit the molecular weight and the viscosity of the melt.

Although NCO/OH ratios of from 0.9 to 1.2 are usually mentioned in the literature on TPUs, the ratios of NCO groups to Zerewitinoff-active hydrogen atoms in concrete recipes are as a rule not more than 1.05. 1.08 is the exception and is chosen at most if monofunctional reaction partners are used.

Diisocyanates such as 4,4′-diphenylmethane-diisocyanate (MDI), 1,6-hexamethylene-diisocyanate (HDI) and 4,4′-dicyclohexane-diisocyanate (H₁₂-MDI) as well as 3,3′-dimethyl-4,4′-biphenyl-diisocyanate (TODI) are chiefly used.

Suitable polyols include both polyester polyols, preferably polyadipates and polycaprolactones, and polyether polyols, e.g., polyether polyols based on tetrahydrofuran and propylene oxide. In high-performance uses, polycarbonate polyols may be used. Mixtures of such polyols are also useful.

Suitable chain extenders include 1,4-butanediol and hydroquinone bis(2-hydroxyethyl)ether (HQEE) which are predominantly used.

In the field of casting elastomers, particularly high-performance systems are obtained by employing NDI, which has to date acquired no practical importance as a raw material for TPUs. Optimum material properties are found for the latter if the ratio of NCO groups to Zerewitinoff-active hydrogen atoms (“NCO index”) chosen is greater than 1.10:1.

In this context, the excess NCO reacts gradually to give allophanate and, where appropriate, biuret groups, and thus forms polyurethane materials of branched or crosslinked structure, which cannot be subjected to thermoplastic processing.

There has been no lack of attempts to obtain the NDI-based advantageous material properties realized only in casting uses, such as favorable abrasion values, low compression set (CS) values, and in particular, outstanding material properties at high use temperatures (e.g., 70 to 100° C.) by thermoplastic processing.

Thermoplastic processing of polyurethanes (PU) has the advantage over the casting technique for the production of industrial parts in that a prefabricated semi-finished product (i.e., TPU granules) merely has to be shaped, and no further chemical reactions which are significantly more difficult to manage have to be carried out. On the other hand, thermoplastic processing also means that the chemical build-up of the TPU materials must be as linear as possible whereas casting elastomers can also be branched or crosslinked. These differences in molecular build-up have an effect on the material properties; for example, the swelling property is always better for chemically branched PU casting elastomers than that of TPUs in systems otherwise built up in the same way.

Generally speaking, PU casting elastomers and TPUs complement each other in a manner which is ideal. The preparation method which leads to an optimum combination of product properties and is simpler (i.e., less expensive) will generally be chosen.

A prerequisite of the freedom of choice with respect to preparation method for PU materials is that NDI-based PU are available in forms for one or the other variant.

In commercial practice, however, NDI-based PU are used exclusively in cast elastomers, but not in thermoplastic processing of TPUs. This is an indication that in spite of the comparatively very expensive preparation process of casting elastomers based on NDI (1,5-naphthalene-diisocyanate, e.g. Desmodur® 15 from Bayer MaterialScience AG), it has not been possible to date to prepare comparable TPUs.

EP-A 0 615 989 discloses that the target parameters of an NCO index of greater than 1.10 and thermoplastic processability, which are irreconcilable, can be combined by subjecting the PU granules to a heat treatment before the thermoplastic reworking.

This heat treatment is technically involved and has not been able to find acceptance in industrial practice.

Other approaches to solving the preparation of NDI-based TPUs are, for example, the preparation of an NDI prepolymer on a reaction extruder and subsequent immediate reaction with the chain extender to give TPU granules. The problems of the NCO excess are not solved by this method. Process technology aspects also make the procedure more difficult. For example, the NDI in the form of flakes necessitates a comparatively involved continuous metering of solid in order to ensure that the NCO prepolymer to be prepared continuously is also constant on a short time-scale with respect to its NCO value and its composition. Further, work hygiene aspects resulting from the comparatively high tendency of NDI towards sublimation necessitate an increased industrial outlay.

A route via an NDI prepolymer which is to be prefabricated, and which would have to be homogeneous with respect to its build up, opens up a way around these problems. Nevertheless, from the group of NDI prepolymers, only those which have a sufficient storage stability can be used. Conventional NDI prepolymers, such as those used on a large scale for the preparation of NDI casting elastomers, are characterized by sparing solubility and a high melting point which cause the unreacted monomeric NDI to precipitate out under storage conditions, e.g., at temperatures below 50° C. Simple heating to temperatures above the melting point of NDI (127° C.), however, does not lead to the desired result because exposure to the high temperatures associated with the melting operation leads to side reactions, and in the end to a drop in the NCO index, together with an increase in the viscosity, so that simple processing is at least made more difficult, if not impossible. A problem here is, in particular, that the ratio of NCO groups to Zerewitinoff-active hydrogen atoms (“NCO index”) changes very greatly, which leads to non-uniform compounds. At the low NCO contents of NDI prepolymers (2.5-6 wt. % NCO) at which the industrially relevant hardness range of PU elastomers can be obtained, such a deviation has a very marked influence on the index and thus on the processing and material properties. Storage of an NDI prepolymer at a high temperature, e.g., above 120° C., is also not a feasible solution, because under these conditions crystallization of the free monomeric NDI is prevented but side reactions lead to a rapid increase in viscosity, and the properties of casting elastomers prepared therefrom also deteriorate dramatically.

The above-mentioned problems of conventional NDI prepolymers which are not storage-stable form the background of processing recommendations which specify the chain lengthening reaction occur within 30 minutes after preparation of the NDI prepolymer, and of reports in the literature which quite generally place in doubt the storage stability of NDI prepolymers. Thus, “Solid Polyurethane Elastomers”, P. Wright and A. P. C. Cummings, Maclaren and Sons, London 1969, p. 104 et seq., chapter 6.2 states the following:

“6.2.1 Unstable Prepolymer Systems (Vulkollan) (Vulkollan®; trade name for casting elastomer systems based on naphthalene-diisocyanate (NDI) from Bayer MaterialScience AG).

Vulkollan systems include a prepolymer, although the prepolymer is non-storable and must be further reacted within a short interval of time. The prepolymer so formed is relatively unstable since further undesirable side reactions can take place. To reduce the possibility of these side reactions occurring, the next stage in the process, viz. the chain extension, should take place as soon as possible but within a maximum of 30 minutes.”

These statements also illustrate why TPUs based on NDI are not available on the market.

### SUMMARY OF THE INVENTION

The object of the present invention was to provide TPUs having the advantageous material properties known to be obtained with NDI casting elastomers, and an industrially advantageous, implementable process for their preparation.

It has been found, surprisingly, that thermoplastic polyurethanes (TPU) based on NDI can be prepared by reacting specific, storage-stable NDI-based NCO prepolymers with chain extenders and granulating the largely reacted and cooled reaction melt. The TPU granules can then be processed to form shaped articles.

### DETAILED DESCRIPTION OF THE INVENTION

The present invention provides a process for the preparation of thermoplastic polyurethanes based on 1,5-naphthalene-diisocyanate (NDI) in which
a) 1,5-naphthalene-diisocyanate (NDI) is reacted continuously or discontinuously with
b) polyols having a temperature of from 80° C. to 240° C., a number-average molecular weight of from 850 to 3,000 g/mol, preferably from 1,000 to 3,000 g/mol, viscosities, measured at 75° C., of <1,500 mPas and a functionality of from 1.95 to 2.15, selected from the group of polyester polyols, poly-ε-caprolactone polyols, polycarbonate polyols, polyether polyols and α-hydro-ω-hydroxy-poly(oxytetramethylene) polyols in a ratio of NCO to OH groups of from 1.55:1 to 2.35:1,
c) optionally, in the presence of auxiliary substances and additives.

After this reaction, the reaction mixture is cooled in a manner such that in each case the dwell time
A) in the temperature range from the end of the reaction to 130° C. does not exceed ½ h and
B) in the temperature range from the end of the reaction to 110° C. does not exceed 1.5 h and
C) in the temperature range from the end of the reaction to 90° C. does not exceed 7.5 hand
D) in the temperature range from the end of the reaction to 70° C. does not exceed 72 h.

The unreacted NDI still present after the conversion reaction is not removed. The storage-stable NCO prepolymer having an NCO content of from 2.5 to 6 wt. % and viscosity, measured at 100° C., of <5,000 mPas obtained in this way is reacted with chain extender(s) at an index (ratio of NCO groups to OH groups from the polyol b) and Zerewitinoff-active hydrogen atoms from the chain extender d) of from 0.95:1 to 1.10:1. The thermoplastic polyurethane (TPU) obtained in this way is cooled and granulated.

If the unreacted NDI is not removed, according to the invention, it is present in amounts of more than 0.3 wt. % and less than 5 wt. %, based on the prepolymer.

Preferably, one or more compounds selected from ethylene glycol, 1,3-propanediol, 1,4-butanediol, 2,3-butanediol, 1,5-pentanediol, 1,6-hexanediol and HQEE are used as chain extender(s).

Preferably, the ratio of NCO groups to Zerewitinoff-active groups in the TPU is in the range of from 0.98 to 1.05 and the hardnesses of the TPU are in the range of from 70 Shore A to 70 Shore D, preferably from 80 Shore A to 70 Shore D, and the values, measured at 70° C., for the compression set are less than 30% and the ratio of the E′ moduli, measured at 0° C. and at 130° C., is less than 2, preferably less than 1.6, most preferably less than 1.5.

Storage-stable NCO prepolymers based on 1,5-naphthalene-diisocyanate (NDI) are those having an NCO content of from 2.5 to 6 wt. % and a viscosity, measured at 100° C., of <5,000 mPas, which are prepared continuously or discontinuously by reaction of 1,5-naphthalene-diisocyanate (NDI) with one or more polyols having a number-average molecular weight of from 850 to 3,000 g/mol, preferably from 900 to 3,000 g/mol, most preferably from 1,000 to 3,000 g/mol, viscosities, measured at 75° C., of <1,500 mPas and a functionality of from 1.95 to 2.15, from the group of polyester polyols, poly-ε-caprolactone polyols, polycarbonate polyols, polyether polyols and α-hydro-ω-hydroxy-poly(oxytetramethylene) polyols in a ratio of NCO to OH groups of from 1.55:1 to 2.35:1, preferably, 1.60:1 to 2.15:1, most preferably, 1.70:1 to 2.00:1, at a temperature of from 80° C. to 150° C. Auxiliary substances and additives may optionally be included.

The reaction mixture is cooled rapidly after the reaction in accordance with the cooling stages described above.

The polyester polyols useful for preparing the prepolymers of the present invention are usually prepared in accordance with the prior art by poly-condensation of one or more polycarboxylic acids, optionally a polycarboxylic acid derivative, with a molar excess of short-chain polyol, optionally polyol mixtures, and optionally one or more catalysts. Typical short-chain polyols are alkylene diols having 2 to 12 C atoms. Poly-ε-caprolactone polyols are obtained by ring-opening polymerization of ε-caprolactone employing predominantly bifunctional starter molecules, including water. Polycarbonate polyols are compounds which have hydroxyl end groups, contain on average at least 3 carbonate groups and are obtained by the synthesis routes known to the person skilled in the art, e.g. by polycondensation of, e.g., phosgene, diphenyl carbonate or dimethyl carbonate with at least one alkylene diol having 2 to 12, preferably 4 to 12 C atoms.

Suitable polyether polyols are predominantly polypropylene oxides or polypropylene-co-ethylene oxides which are polymerized with bifunctional starters and are obtained, e.g., under catalysis by alkali metal hydroxides or double metal complexes. α-Hydro-ω-hydroxy-poly(oxytetramethylene) polyols are obtained by ring-opening polymerization of tetrahydrofuran with the aid of strongly acid catalysts.

The preparation of the NDI prepolymers of the present invention is carried out by heating the polyol to a temperature of from 80 to 150° C. and stirring it with NDI. The precise starting temperature for the prepolymer formation depends on the size of the batch and the nature of the vessel and is determined in preliminary experiments such that, as a result of the exothermicity of the reaction, a temperature maximum is reached which is sufficient for the NDI employed to be melted in the reaction mixture or for a clear homogeneous melt to be obtained. If 1,5-NDI is used, the temperature maximum required is, for example, in the range of from 120 to 135° C., most preferably 125-130° C. When a clear, homogeneous melt is reached (end of the reaction), the NCO prepolymer obtained can be further reacted directly, or advantageously, for the purpose of later further processing, can be cooled rapidly to below 70° C., transferred into storage or transportation vessels and then stored at room temperature until it is to be used. In connection with the process according to the invention, rapid cooling (from the temperature at the end of the reaction) to below 70° C. means the following:
A) maximum dwell time of ½ h in the temperature range from the end of the reaction to a temperature of 130° C. and
B) maximum dwell time of 1.5 h in the temperature range from the end of the reaction to a temperature of 110° C. and
C) maximum dwell time of 7.5 h in the temperature range from the end of the reaction to a temperature of 90° C. and
D) maximum dwell time of 72 h in the temperature range from the end of the reaction to a temperature of below 70° C.

It is, of course, easier to observe these cooling requirements industrially when smaller amounts of NCO prepolymers are to be cooled rapidly. On the laboratory scale, i.e. with amounts of up to approx. 10 kg, under certain circumstances, cooling with air, optionally liquid media (e.g., water baths or oil baths), is sufficient. Whereas on an industrial scale, i.e. with amounts of, e.g., 100 kg or 5 tons, either effective heat exchanger systems or the usually less cost-intensive variant of discharge of the hot reaction product into earlier, already cooled material with intensive stirring or pumping are possible. The already cooled material here is in a stirred tank, the temperature of the already cooled material is chosen based on the ratios of amounts of fresh to earlier material so that the temperature of the mixture is at most 100° C. after the end of the discharging step. The discharging operation must be configured so that all the required conditions with respect to the cooling speed can be maintained for all contents of earlier and fresh product. The mixture of earlier and fresh product content quenched to temperatures of not more than 100° C. which is obtained in this way is then cooled further to temperatures of below 70° C., where appropriate by cooling the tank. In this phase of the process, the transfer operation into storage containers is operated in parallel to an extent which both ensures that sufficient product remains in the discharge container at a temperature which allows quenching of the next part batch to the above-mentioned temperature to be ensured, and that the exposure to heat overall is minimized.

For the preparation of larger amounts, however, it is often more favorable, i.e. simpler and less expensive, to carry out the preparation not in a discontinuous procedure in reaction tanks, but in a continuous procedure by means of reaction extruders.

The preparation of NCO prepolymers on reaction extruders is known. The extruder process is likewise carried out in the preparation of thermoplastic polyurethanes, the NCO prepolymer not being isolated as such but being further reacted directly in the reaction extruder to give the thermoplastic polyurethane. Thus, DE-A 42 17 367 discloses that substantially linear polyester polyols having molar masses of from 500 to 5,000 g/mol are reacted with diisocyanates in an NCO/OH ratio of from 1.1:1 to 5.0:1 to give NCO prepolymers.

A further variant of the process according to the invention is therefore that of carrying out the process for the preparation of the storage-stable NCO prepolymers continuously in reaction extruders. The reaction mixture of polyol and NDI is heated to temperatures of from at least 180° C. to at most 240° C. in one of the first zones of the extruder and is cooled rapidly to temperatures of preferably below 100° C., more preferably below 80° C., in the following zones of the extruder by applying a reduced pressure for substantial devolatilization and by cooling. The melt obtained is transferred into vessels filled with inert gas and stored. The intermediate step of collection and storage of the NDI prepolymer prepared on an extruder of course also bypasses the above-mentioned problems of metering of solid NDI, since variations in amounts on a short time axis are not translated directly into variation in the index of the TPU by this means, but a homogeneous NCO prepolymer is obtained, which is further processed to the TPU only later.

If the extruder variant is employed, an anti-ageing agent is expediently added to the polyol mixture.

The conditions defined above for the cooling operation can of course be adhered to without problems if a reaction extruder is employed, by also choosing the throughput appropriately, in addition to establishing the temperatures in the individual heating and cooling zones.

The polyols which are used for the preparation of the NCO prepolymers are preferably stored in a reservoir vessel at elevated temperature before their use. Storage of the polyester polyols in the temperature range of from 100 to 140° C. and storage of the polyether polyols at temperatures of from 80 to 120° C. have proven to be advantageous.

The storage-stable NDI prepolymers furthermore have the advantage that the unreacted aromatic diisocyanates still present after the conversion reaction are not removed and are present in amounts of more than 0.3 wt. % and less than 5 wt. %, based on the prepolymer.

The TPUs are prepared by first heating the storage-stable NDI prepolymers, which have been prepared in the tank process or in the extruder process and stored, to temperatures of at least 60° C. and thereby converting them into a viscosity range favorable for processing. The storage-stable NDI prepolymers are then reacted in the form of a clear homogeneous melt, using a mixing unit, such as a stirrer, mixing head or reaction extruder, with chain extenders, preferably chain extenders containing hydroxyl groups, optionally chain extender mixtures having average functionalities of from 1.9 to 2.2 and molecular weights or number-average molecular weights of from 62 to 400 g/mol.

Chain extenders containing hydroxyl groups for the preparation of TPUs contain 2 to 12 C atoms. Particularly preferred chain extenders are: ethylene glycol, 1,3-propanediol, 1,4-butanediol, 2,3-butanediol, 1,5-pentanediol, 1,6-hexanediol and HQEE (hydroquinone di(β-hydroxyethyl)ether).

The ratio of NCO groups of the NDI prepolymers to Zerewitinoff-active H atoms in the present invention is in the range of from 0.95:1 to 1.10:1, preferably from 0.95:1 to 1.05:1, most preferably from 0.98:1 to 1.05:1, the theoretical NCO content to be expected on the basis of the stoichiometry being taken as the basis for calculating the NCO content.

The chain lengthening reaction can of course be carried out in the presence of auxiliary substances and additives, such as release agents, antioxidants, hydrolysis stabilizers (e.g., carbodiimides), UV stabilizers (e.g., 2,6-dibutyl-4-methylphenol), flameproofing agents, fillers and catalysts. An overview is contained e.g. in

G. Oertel, Polyurethane Handbook, 2nd edition, Carl Hanser Verlag, Munich, 1994, chap. 3.4.

On an industrial scale, if a reaction extruder is used, the TPU is initially obtained in the form of a strand, which is usually cooled (e.g., by means of water) directly after leaving the reaction extruder and is then granulated. Alternatively, the reactants can also be reacted in static mixers, mixing heads, etc., and the reaction melt discharged on to belts or metal sheets and then comminuted.

TPU granules obtained in this way are shaped thermoplastically to industrial parts on an injection molding machine, optionally after storage and prior drying, the injection-molded bodies assuming their final properties by after-treatment at elevated temperature (conditioning).

The TPUs are distinguished in that they lie at the same level as analogous casting elastomers with respect to the tensile stress and elongation properties and with respect to the thermal properties.

The CS values (compression set) (CS 70° C./24 h) at an elastomer hardness of, for example, approximately 95 Shore A, are furthermore approx. 16-24%, whereas conventional TPUs of the same hardness based on MDI typically have values above 35%.

Even in the case of CS values determined at 120° C. (24 h), the TPUs prepared by the process according to the invention show values below 50%, whereas TPUs of the same hardness based on MDI show creep phenomena under these conditions.

The TPUs are furthermore distinguished in that the complex E′ modulus in the use temperature range is largely independent of temperature, i.e. the ratio of the value measured at 0° C. and that measured at 130° C. is less than 2, preferably less than 1.6, most preferably less than 1.5.

Further, the NDI-based TPUs of the present invention can be processed in an excellent manner, i.e. they require no processing conditions which are unusual for TPU, such as very high melt temperatures or pressures, and show no sign of crosslinking after a relatively long standing time in the barrel of the injection molding machine.

The invention is to be explained in more detail with the aid of the following examples.

### EXAMPLES

### Starting Compounds Used

Polybutylene adipate, OH number (OHN) 50, prepared from adipic acid and butanediol
Polybutylene adipate, OHN 120, prepared from adipic acid and butanediol
Poly-ε-caprolactone started from neo-pentyl glycol, having a hydroxyl number of 70 mg KOH/g

### 1,6-Hexanediol

Desmodur® 44 N (4,4′-diphenylmethane-diisocyanate) from Bayer MaterialScience AG
Hydroquinone di(β-hydroxyethyl)ether (HQEE), crosslinking agent 30/10 from Rheinchemie
Anox® 20 AM, an antioxidant from Great Lakes
Loxamid® EBS, an antiblocking agent from Cognis
Irganox® 1010, an antioxidant from Ciba
Desmodur® 15 (naphthalene-diisocyanate) from Bayer MaterialScience AG

### Example 1

### Preparation of an NDI-Based, Storage-Stable NCO Prepolymer (According to the Invention)

100 parts by weight (pbw) of a poly-ε-caprolactone started from neo-pentyl glycol and having a hydroxyl number of 70 mg KOH/g were dewatered and stirred with 26.03 pbw of Desmodur® 15 polyisocyanate at 118° C. After 11 minutes, the reaction temperature increased to 129° C. The mixture was cooled to 65° C. in the course of 10 min. The prepolymer was divided into several samples and the samples were analyzed after various storage times and the viscosity (measured at 120° C.), the appearance (evaluated at a temperature of 50° C.) and the NCO value were determined (see Table 1).

TABLE 1
Storage conditions and properties of the prepolymer

| | | | | NCO | |
|---|---|---|---|---|---|
| Pre- | Storage | | | value | Appear- |
| polymer | temperature | Time | Viscosity | [wt. % | ance |
| no. | [° C.] | [h] | [mPas] at T | NCO] | [at 50° C.] |
| 1.1 | 65 | 16 | 1,320 at 120° C. | 3.9 | clear |
| 1.2 | 80 | 48 | 1,440 at 120° C. | 3.8 | clear |
| 1.3 | 100 | 24 | 1,920 at 120° C. | 3.6 | clear |
| 1.4 | 23 | 1,000 | 1,320 at 120° C. | 3.9 | clear |
| 1.5 | 23 | 0 | 1,320 at 120° C. | 3.9 | clear |

The storage conditions chosen in Table 1 cover various conceivable exposures to temperature to which the prepolymer could be subjected after its preparation. Thus, for example, “16 h at 65° C.” (prepolymer 1.1, Table 1) simulates the cooling operation to which the prepolymer could be exposed in the worst case after its transfer into relatively small drums, e.g., 60 l cans. “48 h at 80° C.” (prepolymer 1.2, Table 1) and “24 h at 100° C.” (prepolymer 1.3, Table 1) could represent heating up operations before further processing. “1,000 h at 23° C.” (prepolymer 1.4, Table 1) is a time-span required after preparation until further processing. The same viscosity value was found here as at the start of the storage at room temperature (prepolymer 1.5, Table 1). It is thus ensured that after their preparation, storage and conversion into a processable state (heating up), the prepolymers employed according to the invention are suitable for the preparation of PU elastomers.

### Example 2

### Preparation of NCO Prepolymers Employed According to the Invention and not Used According to the Invention

The prepolymers were prepared as described under Example 1. The recipes and the properties of the prepolymers are to be found in Table 2.

Prepolymer 2.4 (Table 2), for example, was prepared as follows:

80 pbw of a poly-ε-caprolactone started from neo-pentyl glycol and having a hydroxyl number of 70 mg KOH/g were dewatered and stirred with 20.48 pt. by wt. of Desmodur® 15 polyisocyanate at 118° C. After 11 minutes, the reaction temperature increased to 129° C. The mixture was cooled to 65° C. in the course of 10 min. The prepolymer was divided into several samples and the samples were analyzed after various storage times (24 h, 48 h and 1.5 months) at various storage temperatures (room temperature, 80° C. and 100° C.), the viscosity (measured at 100 and 120° C.), the appearance (evaluated at a temperature of 23° C.) and the NCO value was determined (see Table 2).

TABLE 2
Preparation of NCO prepolymers and their properties

| | | Example: | | | | | | |
|---|---|---|---|---|---|---|---|---|
| | | 2.1C | 2.2C | 2.3 | 2.4 | 2.5 | 2.6 | 2.7C |
| Poly-ε-caprolactone*⁾ | [pbw] | 80 | 80 | 80 | 80 | 80 | 80 | 80 |
| Desmodur ® 15 polyisocyanate | [pbw] | 11.55 | 14.70 | 18.38 | 20.48 | 20.48 | 24.15 | 28.35 |
| Molar ratio of Desmodur ® 15 | | 1.1:1 | 1.4:1 | 1.75:1 | 1.95:1 | 1.95:1 | 2.3:1 | 2.7:1 |
| polyisocyanate/poly-ε- | | | | | | | | |
| caprolactone | | | | | | | | |
| Free NDI (theory) | [wt. %] | 0.60 | 1.00 | 1.49 | 2.38 | 2.38 | 3.50 | 4.00 |
| Start temp. polyol | [° C.] | 112 | 116 | 118 | 117 | 117 | 122 | 125 |
| Exothermic Tₘₐₓ | [° C.] | 129.5 | 128.1 | 129.5 | 127.6 | 127.3 | 125.9 | 125.7 |
| Reaction time to Tₘₐₓ | [min] | 16 | 13 | 17 | 11 | 16 | 12 | 12 |
| NCO, theory | [wt. %] | 0.46 | 1.77 | 3.20 | 3.98 | 3.98 | 5.24 | 6.58 |
| NCO, found | [wt. %] | 0.28 | 1.58 | 2.95 | 3.66 | 3.72 | 5.03 | 6.32 |
| Viscosity**⁾ | [mPas@120° C.] | >100,000 | 8,700 | 1,650 | 1,110 | 1,050 | 625 | 435 |
| Viscosity**⁾ | [mPas@100° C.] | >100,000 | 18,500 | 3,100 | 2,150 | 2,050 | 1,020 | 815 |
| Viscosity after | | | | | | | | |
| 24 h at 100° C. | [mPas@120° C.] | n.d. | 15,200 | 4,550 | 2,700 | 2,600 | 1,220 | 875 |
| 24 h at 100° C. | [mPas@100° C.] | n.d. | 38,900 | 10,400 | 4,850 | 4,700 | 2,120 | 1,700 |
| 48 h at 80° C. | [mPas@120° C.] | n.d. | 14,700 | 2,350 | 1,350 | 1,350 | 800 | 545 |
| 48 h at 80° C. | [mPas@100° C.] | n.d. | 35,400 | 4,700 | 2,400 | 2,430 | 1,500 | 1,035 |
| 1.5 months/room temp. | [mPas@120° C.] | n.d. | 10,700 | 1,900 | 1,250 | 1,100 | 700 | 540 |
| 1.5 months/room temp. | [mPas@100° C.) | n.d. | 23,000 | 3,700 | 2,450 | 2,250 | 1,405 | 1,114 |
| NCO after | | | | | | | | |
| 24 h at 100° C. | [wt. %] | n.d. | 1.38 | 2.63 | 3.37 | 3.32 | 4.54 | 5.79 |
| 48 h at 80° C. | [wt. %] | n.d. | 1.47 | 2.78 | 3.56 | 3.59 | 4.72 | 5.97 |
| 1.5 months/room temp. | [wt. %] | n.d. | 1.51 | 2.86 | 3.58 | 3.64 | 4.78 | 6.42 |
| State of aggregation | | | | | | | | |
| After 1 day | | solid | cloudy | clear | clear | clear | clear | cloudy |
| After 3 days | | solid | cloudy | clear | clear | clear | clear⁺⁾ | solid |
| After 7 days | | solid | cloudy | cloudy | clear | clear | clear⁺⁾ | solid |
| Specks after 1.5 months | | solid | No | no | yes | yes | yes | yes |
| Clear melt at | [° C.] | | 50 | 50 | 60 | 50 | 85 | >95 |

*⁾Poly-ε-caprolactone started from neo-pentyl glycol and having a hydroxyl number of 70 mg KOH/g
**⁾Viscosity values were determined with a Haake viscometer
⁺⁾Clear, traces of solid NDI C Comparison

The examples of Table 2 illustrate that such prepolymers can be used, i.e. both with respect to their melting properties and with respect to their rheology, in particular also the rheology after storage, only if the molar ratios claimed for the diisocyanate to the polyol are adhered to (Examples 2.3 to 2.6, Table 2).

### Example 3

Analogously to Example 2, 100 pbw of a poly-ε-caprolactone started from neo-pentyl glycol and having a hydroxyl number of 70 mg KOH/g were dewatered and stirred with 26.03 pbw of Desmodur® 15 polyisocyanate at 118° C. After 11 minutes, the reaction temperature increased to 130° C. (end of the reaction). Thereafter, the mixture was divided into various batches, which were exposed to various temperatures and storage times. The time necessary to reach the stated storage temperature varied, since the amounts were comparatively small, within the range of minutes. To establish comparability of the measurement results, the viscosity was recorded at 100° C. independently of the previously established storage temperature using a “Physica MCR 51” viscometer from Anton Paar. The method known to the person skilled in the art of reaction with excess dibutylamine and back-titration thereof was in each case employed for measurement of the NCO content.

TABLE 3

| | Temperature | Cooling time | | | | Total time to | | | Dwell time in the | | | | |
|---|---|---|---|---|---|---|---|---|---|---|---|---|---|
| | during | [min] | | | Storage | viscosity | | NCO | temperature segment | | | | Meets dwell time |
| Exper- | preparation | To | | | temperature | measurement | Viscosity | content | [h] | | | | in temperature |
| iment | [° C.] | 110° C. | 90° C. | 70° C. | [° C.] | [h] | [mPas] | [wt. %] | A)¹ | B)² | C)³ | D)⁴ | segment |
| 3-0 | 130 | | | | 130 | 0 | 1,450 | 3.86 | | | | | |
| 3-1 (c) | 130 | | | | 130 | 0.5 | 1,550 | 3.83 | 0.5 | | | | A) |
| 3-2 (c) | 130 | | | | 130 | 1 | 1,790 | 3.77 | 1 | | | | none |
| 3-3 (c) | 130 | | | | 130 | 2 | 2,150 | 3.70 | 2 | | | | none |
| 3-4 (c) | 130 | | | | 130 | 4 | 4,660 | 3.44 | 4 | | | | none |
| 3-5 (c) | 130 | 60 | | | 110 | 1 | 1,640 | 3.82 | 0 | 1 | | | A) and B) |
| 3-6 (c) | 130 | 60 | | | 110 | 2 | 1,710 | 3.81 | 0 | 2 | | | A) |
| 3-7 (c) | 130 | 60 | | | 110 | 4 | 2,050 | 3.74 | 0 | 4 | | | A) |
| 3-8 (c) | 130 | 60 | | | 110 | 24 | 4,820 | 3.62 | 0 | 24 | | | A) |
| 3-9 (c) | 130 | 7 | 55 | | 90 | 1 | 1,590 | 3.83 | 0 | 0.12 | 1 | | A), B) and C) |
| 3-10 (c) | 130 | 7 | 55 | | 90 | 8 | 1,680 | 3.79 | 0 | 0.12 | 8 | | A), B) |
| 3-11 (c) | 130 | 7 | 55 | | 90 | 24 | 1,860 | 3.66 | 0 | 0.12 | 24 | | A), B) |
| 3-12 (c) | 130 | 7 | 55 | | 90 | 72 | 3,230 | 3.43 | 0 | 0.12 | 72 | | A), B) |
| 3-13 ati. | 130 | 4 | 12 | 50 | 70 | 8 | 1,440 | 3.83 | 0 | 0.07 | 0.2 | 8 | A), B), C) and D) |
| 3-14 ati. | 130 | 4 | 12 | 50 | 70 | 24 | 1,560 | 3.80 | 0 | 0.07 | 0.2 | 24 | A), B), C) and D) |
| 3-15 ati. | 130 | 4 | 12 | 50 | 70 | 48 | 1,640 | 3.74 | 0 | 0.07 | 0.2 | 48 | A), B), C) and D) |
| 3-16 ati. | 130 | 4 | 12 | 50 | 70 | 72 | 1,660 | 3.68 | 0 | 0.07 | 0.2 | 72 | A), B), C) and D) |

(c) = comparison
ati. = according to the invention
A)¹ = temperature from end of reaction to 130° C.
B)² = temperature from end of reaction to 110° C.
C)³ = temperature from end of reaction to 90° C.
D)⁴ = temperature from end of reaction to 70° C.

Table 3 shows that NCO prepolymers have the lowest viscosity, i.e. can be further processed the best, if cooling is carried out as rapidly as possible to the lowest possible temperatures. In Examples 3-13 to 3-16, the maximum dwell times are adhered to, and prepolymers having low viscosities are obtained.

It is thus important that all 4 framework conditions are observed. For example, if a prepolymer is kept at 130° C. for 4 h (Experiment 3-4), it already has a viscosity of 4,660 mPas and the NCO content has already degraded to 3.44 wt. %.

### Example 4

### Preparation of TPU Granules from NDI-Based, Storage-Stable NCO Prepolymers (According to the Invention)

100 pbw of an NCO prepolymer (2.4 from Example 2) stored at room temperature for approx. 45 days were heated to 100° C. in a tin can and stirred with 3.98 pbw of 1,4-butanediol. After 190 seconds, the reacting melt was poured on to metal sheets. After cooling, the cast sheets were cut into strips, granulated and fed to further processing.

Further recipes are listed in Table 4.

### Example 5

### Production of TPU Test Specimens (According to the Invention)

The granules produced in Example 4 were dried in a dry air dryer at 80° C. for 2 hours in order to remove adhering moisture. Test specimens were produced on a Mannesmann D60-182 injection molding machine, the following temperature profile being used: zone 1: 180° C., zone 2: 200° C., zone 3: 200° C., zone 4: 210° C. The melt temperature was 217° C.

The test specimens were conditioned at 110° C. for 12 and 24 h. SI bars were then stamped out. The results of the mechanical investigations are likewise listed in Table 4.

TABLE 4

| Example | | | | | | |
|---|---|---|---|---|---|---|
| 4-1 | 4-2 | 4-3 | 4-4 | 4-5 | 4-6 | 4-7 |

Example:

| | | | | | |
|---|---|---|---|---|---|
| NCO | [pt. by wt.] | 100 | 100 | 100 | 100 |
| prepolymer from | | | | | |
| Ex. 2.4. | | | | | |
| 1,4-Butanediol | [pt. by wt.] | 3.98 | 3.90 | 3.82 | 3.76 |
| Index*) | | 1.00 | 1.02 | 1.04 | 1.06 |

Production of the cast sheets:

| | | | | | |
|---|---|---|---|---|---|
| Prepolymer | [° C.] | 100 | 100 | 100 | 100 |
| temperature | | | | | |
| Casting time | [sec] | 185 | 190 | 185 | 185 |
| Metal sheet | [° C.] | 110 | 110 | 110 | 110 |
| temperature | | | | | |
| After-heating | [h] | 24 | 24 | 24 | 4 |
| time | | | | | |
| After-heating | [° C.] | 110 | 110 | 110 | 110 |
| temperature | | | | | |

Thermoplastic processing:

| | | | | | | | | |
|---|---|---|---|---|---|---|---|---|
| Mold | [° C.] | 20 | 20 | 20 | 20 | 80 | 80 | 20 |
| temperature | | | | | | | | |

After-treatment of the injection-molded NDI-based TPUs:

| | | | | | | | | |
|---|---|---|---|---|---|---|---|---|
| After-heating | [h] | 12 | 12 | 12 | 24 | 12 | 24 | 12 |
| time | | | | | | | | |
| After-heating | [° C.] | 110 | 110 | 110 | 110 | 110 | 110 | 110 |
| temperature | | | | | | | | |

Mechanical properties of the NDI TPUs:

| | | | | | | | | | |
|---|---|---|---|---|---|---|---|---|---|
| DIN 53505 | Shore A | | 94 | 95 | 94 | 94 | 94 | 94 | 94 |
| DIN 53505 | Shore D | | 48 | 48 | 48 | 47 | 47 | 48 | 47 |
| DIN 53504**) | Initial modulus | [N/mm²] | 95.8 | 96.7 | 88.3 | 97.5 | 85.8 | 89.2 | 91.5 |
| DIN 53504**) | Tensile stress | [MPa] | 14.8 | 14.3 | 14.5 | 14.5 | 14.1 | 14.4 | 14.2 |
| | 100% | | | | | | | | |
| DIN 53504**) | Tensile stress | [MPa] | 21.4 | 20.8 | 21.8 | 21.7 | 21.4 | 21.5 | 20.9 |
| | 300% | | | | | | | | |
| DIN 53504**) | Yield stress | [MPa] | 71.9 | 66.5 | 64.3 | 69.5 | 66.3 | 75.6 | 71.7 |
| DIN 53504***) | Yield stress | [MPa] | 43.8 | 44.6 | 49.4 | | | | 50.8 |
| DIN 53504**) | Elongation at | [%] | 688 | 655 | 622 | 649 | 640 | 685 | 678 |
| | tear | | | | | | | | |
| DIN 53504***) | Elongation at | [%] | 727 | 710 | 689 | | | | 694 |
| | tear | | | | | | | | |
| DIN 53515 | Graves | [kN/m] | 106 | 103 | 101 | 103 | 101 | 103 | 98 |
| | Impact | [%] | | | | | | 65 | |
| | resilience | | | | | | | | |
| DIN 53516 | Abrasion (DIN) | [mm³] | 28 | 28 | 28 | | 26 | 24 | 29 |
| DIN 53420 | Density | [g/mm³] | 1.16 | 1.16 | 1.16 | | 1.16 | 1.16 | 1.16 |
| DIN 53517 | CS 22° C./72 h | [%] | 13 | 16 | 14 | | 10 | 12 | 11 |
| DIN 53517 | CS 70° C./24 h | [%] | 17 | 19 | 24 | | 17 | 19 | 19 |
| DIN 53517 | CS 100° C./24 h | [%] | 24 | | 24 | | 26 | 26 | 26 |
| DIN 53517 | CS 120° C./24 h | [%] | 40 | | | | | 42 | 47 |

| | | | | | | |
|---|---|---|---|---|---|---|
| Elasticity modulus E′ (0° C.) | [MPa] | 108 | 117 | 106 | 87.9 | 94.9 |
| Elasticity modulus E′ (130° C.) | [MPa] | 81.6 | 89.9 | 81.2 | 68 | 75.3 |
| Ratio E′(0° C.)/E′(130° C.) | | 1.32 | 1.30 | 1.30 | 1.29 | 1.26 |

*)Index relates to the NCO value found for the prepolymer from Ex. 2.4
**)Tensile test speed: 200 mm/min
***)Tensile test speed: 500 mm/min

Table 4 illustrates with the aid of 4 different formulations, which differ essentially in the index established (1.00 to 1.06), that for the elastomer hardness range of from approx. 94 to 95 Shore A test specimens having almost identical properties are obtained. Thus, for example, the CS values (70° C./24 h) are in the range of 17-24%, rise to 24-26% (100° C./24 h) and even at 120° C. can still be determined, with values of 40-47%. They are significantly superior here to the typical MDI-based systems with similar hardnesses (see Table 6). The latter also applies, e.g., with respect to the yield stress. The exceptionally low dependency of the E′ modulus on the temperature, which manifests itself in unusually low ratios of the value measured at 0° C. and that at 130° C. and is below 1.5, while the MDI system (Table 6) has a value of more than 5, is furthermore characteristic of the TPUs according to the invention of Table 4.

### Example 6

### Preparation of a Casting Elastomer from NDI-Based, Storage-Stable NCO Prepolymer (Comparison Experiments)

100 pbw of the NCO prepolymer from Example 2.4. which had been stored at room temperature for 45 days were heated to 100° C. and degassed. 0.1 pbw of Irganox® 1010 antioxidant and 3.98 pbw of 1,4-butanediol were then stirred in. The reaction mixture was poured into molds preheated to 108° C. to 110° C., and after 18 minutes the specimens were released from the molds and conditioned in a circulating air drying cabinet at 110° C. for 16 h. The mechanical properties were determined (see Table 5).

Further formulations are listed in Table 5.

TABLE 5

| Example | | | | |
|---|---|---|---|---|
| | | | | 6- |
| 6-1(C) | 6-2(C) | 6-3(C) | 6-4(C) | 5(C) |

Example:

| | | | | | | |
|---|---|---|---|---|---|---|
| NCO | [pbw] | 100 | 100 | 100 | 100 | 100 |
| prepolymer | | | | | | |
| from Ex. 2.4 | | | | | | |
| Irganox ® 1010 | [pbw] | 0.1 | 0.1 | 0.1 | 0.1 | 0.1 |
| 1,4-Butanediol | [pbw] | 4.06 | 3.98 | 3.90 | 3.82 | 3.76 |
| Index*) | | 0.995 | 1.015 | 1.036 | 1.057 | 1.074 |

Production:

| | | | | | | |
|---|---|---|---|---|---|---|
| Prepolymer | [° C.] | 100 | 100 | 100 | 100 | 100 |
| temperature | | | | | | |
| Casting time | [sec] | 180 | 190 | 195 | 190 | 190 |
| Solidification | [min] | 10 | 10 | 10 | 10 | 10 |
| Table | [° C.] | 116 | 116 | 116 | 116 | 116 |
| temperature | | | | | | |
| Mold | [° C.] | 110 | 110 | 110 | 110 | 110 |
| temperature | | | | | | |
| After-heating | [h] | 24 | 24 | 24 | 24 | 24 |
| time | | | | | | |
| After-heating | [° C.] | 110 | 110 | 110 | 110 | 110 |
| temperature | | | | | | |

Mechanical properties:

| | | | | | | | |
|---|---|---|---|---|---|---|---|
| DIN 53505 | Shore A | | | | | | |
| DIN 53505 | Shore D | | | | | | |
| DIN 53504 | Tensile stress | [MPa] | 11.07 | 11.54 | 11.27 | 11.05 | 11.36 |
| | 100%***) | | | | | | |
| DIN 53504 | Tensile stress | [MPa] | 16.11 | 16.55 | 16.41 | 16.44 | 16.43 |
| | 300%***) | | | | | | |
| DIN 53504 | Yield | [MPa] | 31.55 | 30.28 | 32.21 | 32.32 | 36.28 |
| | stress***) | | | | | | |
| DIN 53504 | Elongation at | [%] | 539 | 510 | 517 | 501 | 543 |
| | tear***) | | | | | | |
| DIN 53515 | Graves | [kN/m] | 62 | 67 | 62 | 57 | 59 |
| | Impact | [%] | | | | | |
| | resilience | | | | | | |
| DIN 53516 | Abrasion | [mm³] | | | | | |
| | (DIN) | | | | | | |
| DIN 53420 | Density | [g/mm³] | | | | | |
| DIN 53517 | CS 22° C./72 h | [%] | 21.6 | 19.7 | 18.9 | 19.0 | 18.2 |
| DIN 53517 | CS 70° C./24 h | [%] | 41.0 | 34.6 | 36.3 | 35.4 | 30.4 |
| DIN 53517 | CS 100° C./24 h | [%] | 48.0 | 40.4 | 43.1 | 45.4 | 40.1 |

*)Index relates to the NCO value found for the prepolymer from Example 2.4.
***)Tensile test speed: 500 mm/min

Table 5 shows casting elastomer formulations which are substantially identical to the TPU recipes of Table 4 and differ only in the production process. The mechanical properties determined in the tensile test (tensile stress and elongation data) on the casting elastomers of Table 5 likewise vary at the high level generally known for NDI elastomers, but in detail do not quite reach the values of the TPU elastomers. The same also applies to the CS values and the tear propagation resistance (Graves).

Overall, comparison of Tables 4 and 5 shows that by the process according to the invention it is possible to prepare TPUs based on NDI such that they achieve or exceed the level of properties of corresponding casting elastomers based on NDI.

### Example 7

### Preparation of a TPU Based on 4,4′-MDI (Comparison Experiment)

80 pbw of a poly(butylene adipate polyol) terminated by hydroxyl groups and having an OH number of 50 mg KOH/g, 20 pbw of a poly(butylene adipate polyol) terminated by hydroxyl groups and having an OH number of 120 mg KOH/g and 1 pt. by wt. of 1,6-hexanediol were heated at 100° C. in a tin can and stirred with 50 pbw of 4,4′-diphenylmethane-diisocyanate (MDI). After the exothermic reaction had subsided, 24.83 pbw of HQEE, 0.830 pbw of Loxamid® EBS antiblocking agent and 0.1 pt. by wt. of Anox® 20 PP antioxidant were added. After 190 seconds, the reacting melt was poured on to metal sheets. After cooling, the cast sheets were cut into strips, granulated and fed to further processing.

TABLE 6

| | | | Example 7 |
|---|---|---|---|
| Formulation: | Polybutylene adipate, OHN 50 | [pbw] | 80 |
| | Polybutylene adipate, OHN 120 | [pbw] | 20 |
| | 1,6-Hexanediol | [pbw] | 1 |
| | Desmodur 44 (4,4′-MDI) | [pbw] | 50 |
| | HQEE | [pbw] | 24.83 |
| | Anox 20 AM | [pbw] | 0.1 |
| | Loxamid EBS | [pbw] | 4.9 |
| Production of | Metal sheet temperature | [° C.] | 110 |
| the cast sheets: | After-heating time | [h] | 24 |
| | After-heating temperature | [° C.] | 110 |
| Thermoplastic | Mold temperature | [° C.] | 80 |
| processing: | Melt temperature | [° C.] | 220 |
| After-treatment | After-heating time | [h] | 12 |
| of the injection- | After-heating temperature | [° C.] | 110 |
| molded MDI | | | |
| TPUs: | | | |
| Mechanical | | | |
| properties: | | | |
| ISO 868 | Shore A | | 93 |
| ISO 868 | Shore D | | 44 |
| i.a.*) ISO | Tensile stress 100% | [MPa] | 8 |
| 527-1,-3 | | | |
| i.a.*) ISO | Tensile stress 300% | [MPa] | 20 |
| 527-1,-3 | | | |
| i.a.*) ISO | Yield stress | [MPa] | 38 |
| 527-1,-3 | | | |
| i.a.*) ISO | Elongation at tear | [%] | 500 |
| 527-1,-3 | | | |
| ISO 34-1 | Tear propagation resistance | [kN/m] | 95 |
| ISO 4662 | Impact resilience | [%] | 35 |
| ISO 4649 | Abrasion loss | [mm³] | 25 |
| ISO 1183 | Density | [g/cm³] | 1.220 |
| ISO 815 | CS 70° C./24 h | [%] | 35 |
| | Elasticity modulus E′ (0° C.) | [MPa] | 210 |
| | Elasticity modulus E′ (130° C.) | [MPa] | 36 |
| | Ratio E′(0° C.)/E′(130° C.) | | 5.8 |

*)i.a.: in accordance with; tensile test speed 200 mm/min

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of a thermoplastic polyurethane based on 1,5-naphthalene-diisocyanate (NDI) comprising:
a) reacting
(i) 1,5-naphthalene-diisocyanate (NDI)
continuously or discontinuously with
(ii) at least one polyol having a temperature of from 80° C. to 240° C., a number-average molecular weight of from 850 to 3,000 g/mol, viscosity, measured at 75° C., of <1,500 mPas and a functionality of from 1.95 to 2.15, selected from polyester polyols, poly-ε-caprolactone polyols, polycarbonate polyols, polyether polyols and α-hydro-ω-hydroxy-poly(oxytetramethylene) polyols
in a ratio of NCO to OH groups of from 1.55:1 to 2.35:1,
(iii) optionally, in the presence of auxiliary substances and additives to form a prepolymer,
b) cooling the prepolymer-containing reaction mixture in a manner such that the dwell time
(A) in the temperature range from the end of the reaction to 130° C. does not exceed ½ h and
(B) in the temperature range from the end of the reaction to 110° C. does not exceed 1.5 h and
(C) in the temperature range from the end of the reaction to 90° C. does not exceed 7.5 h and
(D) in the temperature range from the end of the reaction to 70° C. does not exceed 72 h
without removing any unreacted NDI present in the prepolymer-containing reaction mixture after the reaction to obtain a storage-stable NCO prepolymer having an NCO content of from 2.5 to 6 wt. % and viscosity, measured at 100° C., of <5,000 mPas,
c) reacting the prepolymer from b) with a chain extender in an amount such that the ratio of NCO groups of (i) to OH groups from the polyol (ii) and Zerewitinoff-active hydrogen atoms from the chain extender is from 0.95:1 to 1.10:1 to form a thermoplastic polyurethane,
and
d) cooling and granulating the thermoplastic polyurethane from c).

2. The process of claim 1 in which the chain extender is selected from ethylene glycol, 1,3-propanediol, 1,4-butanediol, 2,3-butanediol, 1,5-pentanediol, 1,6-hexanediol and hydroquinone di(β-hydroxyethyl)ether.

3. The process of claim 1 in which the thermoplastic polyurethane has a hardness in the range of from 70 Shore A to 70 Shore D and the values for the compression set, measured at 70° C. (24 h), are less than 30% and the ratio of the E′ moduli, measured at 0° C. and at 130° C., is less than 2.

4. The process of claim 3 in which the ratio of the E′ moduli, measured at 0° C. and at 130° C. of the thermoplastic polyurethane is less than 1.6.

5. The process of claim 3 in which the ratio of the E′ moduli, measured at 0° C. and at 130° C. of the thermoplastic polyurethane is less than 1.5.
